(19) United States
(12) Patent Application Publication
(10) Pub. No.: US 2026/0138369 A1
(43) Pub. Date: May 21, 2026

(54) PRINTING DEVICE

(71) Applicant: SEIKO EPSON CORPORATION, Tokyo (JP)

(72) Inventor: Satoru MIYAMOTO, MATSUMOTO-SHI (JP)

(21) Appl. No.: 19/386,487

(22) Filed: Nov. 12, 2025

(30) Foreign Application Priority Data
Nov. 15, 2024 (JP) 2024-199521

(51) Int. Cl. B41J 2/17; B41J 25/00; B41J 29/13; B41J 29/377

(52) U.S. Cl. CPC B41J 2/1714; B41J 25/005; B41J 29/13; B41J 29/377

(57) ABSTRACT

A printing device includes: an open-close cover that includes a first partition wall forming a part of a top surface of a housing and a second partition wall forming a part of a front surface of the housing and opens and closes a part of the housing; a head that is accommodated in the housing and ejects a liquid to a medium from a nozzle surface; a carriage that supports the head, and is guided by a guide shaft extending along a scanning direction and thus moves along the scanning direction; and a suction duct that sucks a gas inside the housing from a suction hole, wherein the suction duct is located on a side opposite to the guide shaft across the head as viewed in a plan view, and is provided at an inner surface of the second partition wall.

The present application is based on, and claims priority from JP Application Serial Number 2024-199521, filed November 15, 2024, the disclosure of which is hereby incorporated by reference herein in its entirety.

### BACKGROUND

### 1. Technical Field

The present disclosure relates to a printing device.

### 2. Related Art

JP-A-2017-56590 discloses a liquid ejection device including a print head that is installed in a carriage and ejects an ink, and a mist collection mechanism that collects mist generated due to the ejection of the ink. The mist collection mechanism collects mist upstream of the print head in the sheet conveyance direction.

JP-A-2017-56590 is an example of the related art.

In the liquid ejection device described in JP-A-2017-56590, the mist collection mechanism is disposed to vertically overlap a guide rail for moving the carriage, and this poses a problem in that the height of the liquid ejection device increases.

### SUMMARY

A printing device includes: an open-close cover that includes a first partition wall forming a part of a top surface of a housing and a second partition wall forming a part of a front surface of the housing and opens and closes a part of the housing; a liquid ejection unit that is accommodated in the housing and ejects a liquid to a medium from an ejection surface; a carriage that supports the liquid ejection unit, and is guided by a guide shaft extending along a scanning direction and thus moves along the scanning direction; and a suction duct that sucks a gas inside the housing from a suction hole, in which the suction duct is located on a side opposite to the guide shaft across the liquid ejection unit as viewed in a plan view, and is provided at an inner surface of the second partition wall.

### BRIEF DESCRIPTION OF THE DRAWINGS

FIG. 1 is a schematic view showing the configuration of a printing device.

FIG. 2 is a perspective view showing the external appearance of the printing device.

FIG. 3 is a perspective view showing a state where an open-close cover of the printing device shown in FIG. 2 is in an open position.

FIG. 4 is a perspective view of the open-close cover when the open-close cover is in the open position, as viewed from the front.

FIG. 5 is a partial perspective view showing the configuration around the open-close cover when the open-close cover is in the open position.

FIG. 6 is a perspective view showing the configuration around the open-close cover when the open-close cover is in a closed position.

FIG. 7 is a partial perspective view showing the configuration around the open-close cover when the open-close cover is in the closed position.

### DESCRIPTION OF EMBODIMENTS

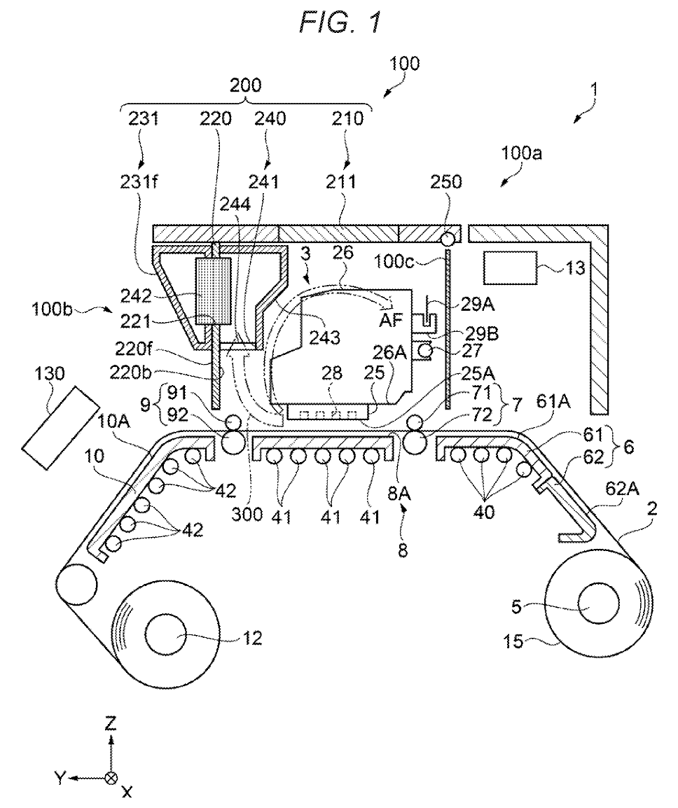

Hereinafter, a printing device 1 according to the present embodiment will be described with reference to the drawings. The printing device 1 illustrated in FIG. 1 is, for example, an inkjet printer that ejects an ink, which is an example of a "liquid", to a conveyed medium 2, and thus prints an image such as a character or a photograph on the medium 2.

In the drawings below, individual members are not to scale in order to show these members in recognizable sizes. In the drawings, the same components are denoted by the same reference numerals, and a repeated description thereof is omitted. Also, in each drawing, an X axis, a Y axis, and a Z axis are illustrated as necessary, as coordinate axes orthogonal to each other. Arrows are attached to the X axis, the Y axis, and the Z axis, respectively. In each of the X axis, the Y axis, and the Z axis, the direction of the arrow is a positive direction, and the direction opposite to the direction of the arrow is a negative direction. A plane including the X axis and the Y axis is described as an XY plane, a plane including the X axis and the Z axis is described as an XZ plane, and a plane including the Y axis and the Z axis is described as a YZ plane.

In the description below, for the convenience of description, the positive direction along the Z axis is also referred to as upward or simply as above, and the negative direction is also referred to as downward or simply as below. Also, the positive direction along the X axis is also referred to as a left direction or simply as left, and the negative direction is also referred to as a right direction or simply as right. Also, the positive direction along the Y axis is also referred to as forward or simply as front, and a surface facing the positive direction along the Y axis is referred to as a front surface. Also, the negative direction along the Y axis is also referred to as rearward or simply as rear, and a surface facing the negative direction along the Y axis is referred to as a back surface.

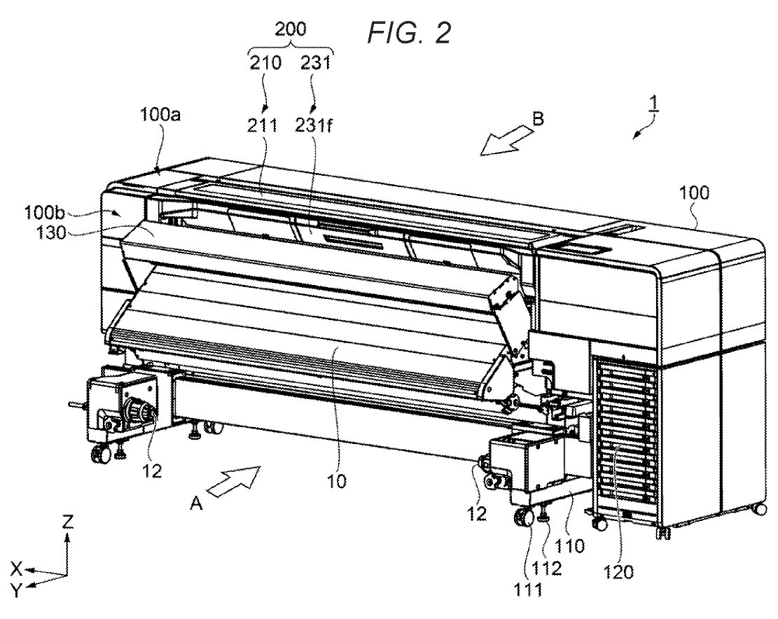

The X-axis direction is the width direction of the printing device 1, the width direction of the medium 2 on which an image is printed, and the width direction of a conveyance path through which the medium 2 is conveyed, and corresponds to a scanning direction in which a carriage 26 moves. The Y-axis direction is the depth direction of the printing device 1 and corresponds to a conveyance direction in which the medium 2 is conveyed below a head 25. Viewing from the +Z direction or the -Z direction is referred to as viewing in a plan view. In FIGS. 2 to 4, an arrow A indicates a direction in which the printing device 1 is viewed from the front side, which is the +Y direction side, to the -Y direction, and an arrow B indicates a direction in which the printing device 1 is viewed from the back side, which is the -Y direction side, to the +Y direction.

The configuration of a printing device 1 will be described with reference to FIGS. 1 to 3. As illustrated in FIG. 1, the printing device 1 includes a feeding shaft 5, an upstream support unit 6, an upstream conveying unit 7, a platen 8, a printing unit 3, a downstream conveying unit 9, a downstream support unit 10, and a take-up shaft 12. The upstream support unit 6, the upstream conveying unit 7, the platen 8, the downstream conveying unit 9, and the downstream support unit 10 are disposed in this order in the conveyance path on which the medium 2 is conveyed. The upstream conveying unit 7 is an example of a "medium conveying unit" that conveys the medium 2 in the conveyance direction.

The printing device 1 further includes an upstream heating unit 40, a print heating unit 41, and a downstream heating unit 42. The printing device 1 further includes a blower 130, a control unit 13, and a housing 100.

The feeding shaft 5 is a rod-shaped member extending along the X-axis direction. The feeding shaft 5 is supported by a frame or the like, not illustrated, at both ends in the X-axis direction. The feeding shaft 5 supports a roll 15 in a rotatable manner, the roll 15 being formed of the long medium 2 wound in a cylindrical shape. The feeding shaft 5 rotates and thus feeds the medium 2 from the roll 15 toward the upstream support unit 6.

The upstream support unit 6, the platen 8, and the downstream support unit 10 are members that support the long medium 2 conveyed in the conveyance direction. The medium 2 is conveyed along the surfaces of the upstream support unit 6, the platen 8, and the downstream support unit 10 in this order. The conveyance direction intersects the X-axis direction. The upstream support unit 6, the platen 8, and the downstream support unit 10 are fixed to a frame or the like, not illustrated, that supports the entirety of the printing device 1.

The upstream support unit 6 includes an upstream heating support unit 61 and an upstream guide support unit 62. The upstream heating support unit 61 and the upstream guide support unit 62 support a part of the medium 2 that is upstream of a part facing the printing unit 3 in the conveyance direction. The upstream heating support unit 61 is heated by the upstream heating unit 40, described later. The upstream guide support unit 62 is located upstream of the upstream heating support unit 61 in the conveyance direction. A second support surface 62A of the upstream guide support unit 62 supports the medium 2 fed from the roll 15. The platen 8 is located downstream of the upstream support unit 6 in the conveyance direction. The medium 2 supported by the upstream support unit 6 is conveyed to the platen 8 by the upstream conveying unit 7.

The upstream conveying unit 7 is located downstream of the upstream support unit 6 in the conveyance direction. The upstream conveying unit 7 is located upstream of the platen 8 in the conveyance direction. The upstream conveying unit 7 includes a first roller 71 and a second roller 72. The first roller 71 and the second roller 72 each extend along the X-axis direction. The upstream conveying unit 7 includes a motor, not shown. The power from the motor is transferred to the second roller 72. The second roller 72 is rotatable with the power from the motor.

The medium 2 is sandwiched between the first roller 71 and the second roller 72. The medium 2 can be conveyed by rotating the second roller 72 in the state where the medium 2 is sandwiched between the first roller 71 and the second roller 72. The upstream conveying unit 7 conveys the medium 2 toward the platen 8.

In the printing device 1, the second roller 72 is a driving roller, and the first roller 71 is a driven roller. The driving roller is rotationally driven with the power from the motor. The driven roller is driven with the rotational driving of the driving roller. The first roller 71 may be a driving roller, and the second roller 72 may be a driven roller.

The platen 8 is located on the -Z direction side of the printing unit 3. The platen 8 faces the printing unit 3 across the conveyance path. The platen 8 supports a part of the medium 2 where printing is performed by the printing unit 3. A support surface 8A, which is a surface of the platen 8 facing the +Z direction, is a surface that supports the medium 2.

The platen 8 can apply a suction force to the medium 2. The support surface 8A of the platen 8 facing the printing unit 3 is flat. The support surface 8A of the platen 8 extends over a range in which the printing unit 3 can perform printing. A configuration in which a suction fan sucks air through a plurality of suction holes formed in the support surface 8A of the platen 8 so as to suck the medium 2 to the support surface 8A of the platen 8 may be employed.

The printing unit 3 includes the head 25, the carriage 26, and a guide shaft 27. A plurality of nozzles 28 for ejecting an ink are formed in the head 25. The plurality of nozzles 28 open to a nozzle surface 25A of the head 25. The nozzle surface 25A is a surface facing the -Z direction and is located, for example, about 0.5 mm in the -Z direction from a lower end 26A of the carriage 26. The guide shaft 27 is a rod-shaped member extending along the X-axis direction. The guide shaft 27 is supported by a frame or the like, not shown, at both ends in the X-axis direction. The head 25 ejecting an ink from the nozzle surface 25A to the medium 2 is an example of a "liquid ejection unit". The nozzle surface 25A is an example of an "ejection surface".

The printing unit 3 further includes a linear scale 29A and an optical sensor 29B. The linear scale 29A and the optical sensor 29B function as a linear encoder for detecting the position of the carriage 26 in the scanning direction. The linear scale 29A extends in the scanning direction. The linear scale 29A is located above the nozzle surface 25A. In the linear scale 29A, a large number of slits are formed at regular intervals. The linear scale 29A is an example of a "position detection unit" that detects the position of the carriage 26.

The optical sensor 29B optically reads a plurality of slits formed in the linear scale 29A and outputs a detection signal corresponding to the number of slits to the control unit 13. The detection signal includes a number of pulse signals proportional to the moving distance of the carriage 26 in the scanning direction. The control unit 13 recognizes the position of the carriage 26 moving in the scanning direction, based on the detection signal.

The carriage 26 supports the head 25 and moves forward and backward together with the head 25 along the X-axis direction, which is the scanning direction, due to the driving of a drive mechanism, not shown, that is controlled by the control unit 13. The carriage 26 is guided by the guide shaft 27 extending along the scanning direction. The head 25 ejects an ink toward the medium 2 while moving, and thus performs printing on the medium 2.

The printing unit 3 in the present embodiment is a so-called serial printer that performs printing while moving forward and backward in the X-axis direction, which is the width direction of the medium 2. The printing unit 3 may be configured as a so-called line printer having the head 25 in which the nozzles 28 are provided over the width dimension of the medium 2.

In the printing device 1, an ink is ejected from the head 25 toward a region of the medium 2 supported by the support surface 8A of the platen 8, and printing is thus performed. The medium 2 supported by the platen 8 is conveyed to the downstream support unit 10 by the downstream conveying unit 9. The medium 2 is conveyed in the +Y direction in a state of being supported by the support surface 8A of the platen 8. The downstream conveying unit 9 is located downstream of the platen 8 in the conveyance direction. The downstream conveying unit 9 is located upstream of the downstream support unit 10 in the conveyance direction.

The downstream conveying unit 9 includes a third roller 91 and a fourth roller 92. The third roller 91 and the fourth roller 92 each extend along the X-axis direction. The downstream conveying unit 9 includes a motor, not shown. The power from the motor is transferred to the fourth roller 92. The fourth roller 92 is rotatable with the power from the motor.

The medium 2 is sandwiched between the third roller 91 and the fourth roller 92. The downstream conveying unit 9 rotates the fourth roller 92 in the state where the medium 2 is sandwiched between the third roller 91 and the fourth roller 92, and thus can convey the medium 2. The downstream conveying unit 9 conveys the medium 2 toward the downstream support unit 10.

In the printing device 1, the fourth roller 92 is a driving roller, and the third roller 91 is a driven roller. The driving roller is rotationally driven with the power from the motor. The driven roller is driven with the rotational driving of the driving roller. The third roller 91 may be a driving roller, and the fourth roller 92 may be a driven roller.

The downstream support unit 10 is located downstream of the platen 8 in the conveyance direction. The downstream support unit 10 supports a part of the medium 2 that is downstream of a part facing the printing unit 3 in the conveyance direction.

The take-up shaft 12 is located downstream of the printing unit 3 in the conveyance direction. The take-up shaft 12 winds up the conveyed medium 2. The take-up shaft 12 is located downstream of the downstream support unit 10 in the conveyance direction. The medium 2 is wound up by the take-up shaft 12 after being conveyed along the downstream support unit 10.

The upstream heating unit 40 is provided at the upstream heating support unit 61. The upstream heating unit 40 heats the medium 2 supported by a first support surface 61A facing the conveyance path, of the upstream heating support unit 61, via the upstream heating support unit 61. The print heating unit 41 is provided at the platen 8. The print heating unit 41 heats the medium 2 supported by the support surface 8A, via the platen 8. The downstream heating unit 42 is provided at the downstream support unit 10. The downstream heating unit 42 heats the medium 2 supported by a downstream support surface 10A facing the conveyance path, of the downstream support unit 10, via the downstream support unit 10, and thus can dry the medium 2.

The blower 130 is provided at a position facing the downstream support unit 10. The blower 130 can blow air to the medium 2 supported by the downstream support unit 10. The blower 130 can promote the drying of the medium 2 by blowing air to the medium 2.

The control unit 13 is a controller that controls the printing device 1. For example, the control unit 13 controls the upstream conveying unit 7 to convey the medium 2 toward the platen 8. The control unit 13 controls the printing unit 3 to eject an ink to the medium 2 supported by the support surface 8A of the platen 8 and thus print an image. The control unit 13 controls the take-up shaft 12 and thus causes the take-up shaft 12 to wind up the medium 2 with the image printed thereon.

The housing 100 defines a part of the outer shell of the printing device 1. The housing 100 forms a part of a front surface 100b, which is a side surface of the printing device 1 on the +Y direction side, and a part of a rear surface, which is a side surface of the printing device 1 on the -Y direction side. The housing 100 forms a right side surface, which is a side surface on the -X direction side of the printing device 1, and a left side surface, which is a side surface on the +X direction side. The housing 100 forms a top surface 100a, which is a surface of the printing device 1 on the +Z direction side.

The printing unit 3, the upstream conveying unit 7, the platen 8, the downstream conveying unit 9, and the control unit 13 are accommodated inside the housing 100.

The housing 100 includes an inner wall 100c that defines the inside of the housing 100 into two spaces, that is, a front space located in the +Y direction and a rear space located in the -Y direction. The inner wall 100c is provided from the right side surface of the housing 100 to the left side surface of the housing 100, inside the housing 100. The front space inside the housing 100 is defined by the medium 2 or the conveyance path for conveying the medium 2, and the housing 100. The head 25, the carriage 26, the guide shaft 27, the linear scale 29A, and a suction duct 240 are accommodated in the front space inside the housing 100.

The housing 100 may include a plurality of members. A part of the housing 100 in the present embodiment is formed by an open-close cover 200. The open-close cover 200 is provided on the front side, which is the +Y direction side of the housing 100. The open-close cover 200 can rotationally move about the axial center of a rotation shaft 250. The open-close cover 200 opens and closes a part of the top surface 100a and a part of the front surface 100b of the housing 100. The rotation shaft 250 couples the open-close cover 200 in a rotatable manner to the top surface 100a, which is not opened and closed. The rotation shaft 250 extends in the X-axis direction, and the axial center of the rotation shaft 250 is along the X axis.

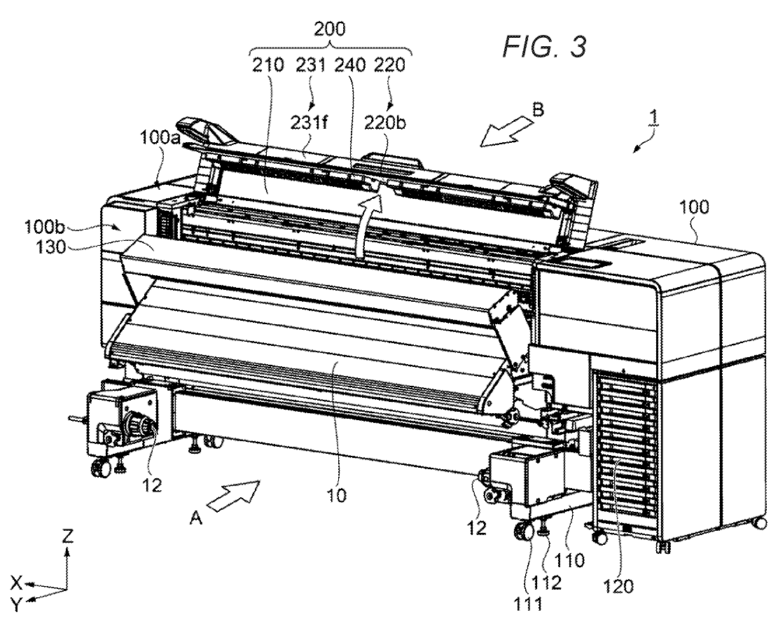

The open-close cover 200 is provided to be rotationally movable between a closed position (see FIGS. 1 and 2) and an open position (see FIG. 3) by rotationally moving around the axial center of the rotation shaft 250. The closed position of the open-close cover 200 is a position where the open-close cover 200 forms a part of the top surface 100a and a part of the front surface 100b of the housing 100 and covers the inside of the housing 100. The open position of the open-close cover 200 is a position where the open-close cover 200 exposes the inside of the housing 100, so that the user can access the inside of the housing 100.

The open-close cover 200 forms a part that covers the upstream conveying unit 7, the platen 8, the downstream conveying unit 9, and the like, of the top surface 100a of the housing 100. The open-close cover 200 forms a part that covers the width direction of the conveyance path of the medium 2, of the front surface 100b of the housing 100.

The open-close cover 200 includes a first partition wall 210 forming a part of the top surface 100a of the housing 100 when in the closed position, and a second partition wall 220 forming a part of the front surface 100b of the housing 100 when in the closed position.

The first partition wall 210 has a substantially rectangular shape along the XY plane and elongated in the X-axis direction. The first partition wall 210 has a window 211.

The window 211 is located on the +Z direction side above the support surface 8A of the platen 8. The window 211 is located on the +Z direction side above the movement region of the carriage 26 along the X-axis direction. The window 211 is formed of a light-transmissive member. Thus, in the state where the open-close cover 200 is in the closed position, the inside of the housing 100 is visible from outside the housing 100 through the window 211.

The second partition wall 220 is provided on the front side of the first partition wall 210. The second partition wall 220 is provided on the -Z direction side of the first partition wall 210. The second partition wall 220 has a substantially rectangular shape along the XZ plane and elongated in the X-axis direction. The second partition wall 220 is formed of, for example, a light-transmissive resin member.

An upper end part of the second partition wall 220, which is an end on the +Z direction side, is fixed to a surface of the first partition wall 210 on the -Z direction side. A lower end part of the second partition wall 220, which is an end on the -Z direction side, is located on the +Z direction side of the medium 2 and faces the medium 2 with a gap therebetween.

As shown in FIGS. 2 and 3, a leg frame 110 is provided near the two ends of the housing 100 in the X-axis direction. A caster 111 and an adjuster 112 are provided below the leg frame 110. The user can easily move the printing device 1 by using the caster 111. By using the adjuster 112, the user can adjust the heights of a plurality of parts and suitably install the printing device 1 on the installation surface.

The printing device 1 includes a liquid supply unit 120 that supplies an ink to the head 25 of the printing unit 3. The liquid supply unit 120 is configured to supply an ink to the head 25 via a liquid supply path, not illustrated. As the ink, for example, an ink having various known compositions can be used, such as a water-based dye ink or a pigment ink, an organic solvent-based (eco-solvent-based) ink having higher weather resistance than these water-based inks, and a photocurable ink which is cured by irradiation with ultraviolet rays.

As the ink is ejected from the nozzles 28 of the head 25, ink mist, which is fine particles of the ink, may be generated. The ink mist generated due to the printing on the medium 2 is spread into the front space inside the housing 100 by a turbulent flow generated due to the movement of the carriage 26. Therefore, a gas 300 staying in the front space inside the housing 100 contains the ink mist. The printing device 1 according to the present embodiment has a configuration for sucking the ink mist.

The configuration for sucking the ink mist will be described with reference to FIGS. 1 to 7. The printing device 1 includes the suction duct 240, a filter 242, an outer duct 231, a coupling part 230, an inner duct 232, a vertical duct 233, and an air flow generation unit 234, as the configuration for sucking the gas 300 containing the ink mist. The gas 300 inside the housing 100 is sucked by the air flow generation unit 234 in the above-described order and discharged to outside the housing 100.

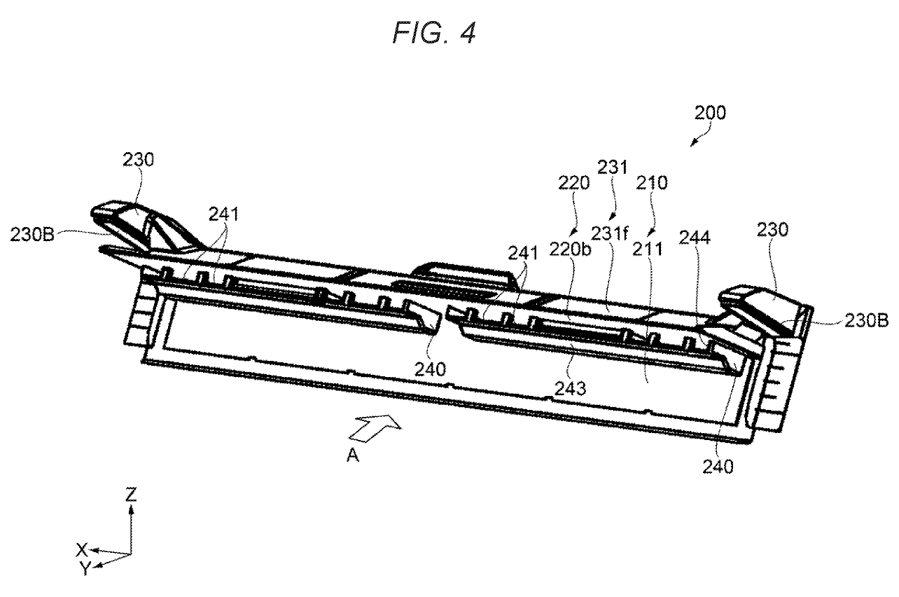

As illustrated in FIGS. 1 and 4, at the inner surface 220b of the second partition wall 220, two suction ducts 240 that suck the gas 300 inside the housing 100 are provided side by side over the width direction of the conveyance path of the medium 2. As shown in FIG. 1, in the state where the open-close cover 200 is in the closed position, the suction duct 240 is provided at a position opposite to the guide shaft 27 across the head 25 as viewed in a plan view.

The second partition wall 220 extends below the suction duct 240. As described above, the second partition wall 220 is formed of a light-transmissive resin member. When the open-close cover 200 is in the closed position, a part of the second partition wall 220 located below the suction duct 240 is exposed as the front surface 100b of the housing 100. Thus, in the state where the open-close cover 200 is in the closed position, the inside of the housing 100 is visible from outside the housing 100 through the lower side of the second partition wall 220.

In the state where the open-close cover 200 is in the closed position, the suction duct 240 is located on the side opposite to the linear scale 29A across the head 25 as viewed in a plan view. The suction duct 240 is located above the nozzle surface 25A. The suction duct 240 is located downstream of the carriage 26 in the conveyance direction. Thus, for example, when printing is performed on the medium 2 using the organic solvent-based ink, the suction duct 240 can suck the organic solvent volatilized from the medium 2 inside the housing 100, which is preferable. In the present embodiment, a case where two suction ducts 240 are provided is described, but the present disclosure is not limited thereto. One or more suction ducts 240 may be provided.

As shown in FIG. 4, a plurality of suction holes 241 are formed along the X-axis direction in the suction duct 240. As illustrated in FIG. 1, the suction duct 240 sucks the gas 300 inside the housing 100 from the suction hole 241. An inner surface 220b where the suction duct 240 is provided is a surface facing the -Y direction that defines the front space inside the housing 100, of the surfaces of the second partition wall 220. Thus, a suction space into which the gas 300 sucked from the suction hole 241 flows is formed between the suction duct 240 and the second partition wall 220. As shown in FIG. 4, each of the plurality of suction holes 241 in one suction duct 240 communicates with one suction space into which the gas 300 flows.

As shown in FIG. 1, the suction duct 240 is provided near the upper end of the second partition wall 220 in the Z-axis direction. The suction duct 240 is formed of, for example, a resin member. A lower surface 244, which is an end part of the suction duct 240 on the -Z direction side, is located on the +Z direction side of a lower end part of the second partition wall 220. The lower surface 244 of the suction duct 240 is located on the +Z direction side of the nozzle surface 25A of the head 25. In the Z-axis direction, the distance between the lower surface 244 of the suction duct 240 and the nozzle surface 25A is longer than the distance between the support surface 8A and the nozzle surface 25A.

The suction hole 241 is located above the nozzle surface 25A. The suction hole 241 is formed at a position close to the nozzle surface 25A, in the suction duct 240. That is, the suction hole 241 is formed at a position close to the region where the nozzle surface 25A moves, in the member partitioning the inside and the outside of the suction duct 240. Specifically, the suction holes 241 are formed side by side at the lower surface 244 of the suction duct 240 and open in the -Z direction. The suction holes 241 are formed along the X-axis direction, which is the scanning direction. In this way, since the suction holes 241 are located above the nozzle surface 25A and are formed along the scanning direction, the suction duct 240 sucks up the gas 300 in the vicinity of the nozzle surface 25A, following the movement of the carriage 26. In the present embodiment, a case where the plurality of suction holes 241 are formed in the suction duct 240 is described, but the present disclosure is not limited thereto. One or more suction holes 241 may be provided in the suction duct 240. In this case, the suction hole 241 is preferably provided over the X-axis direction in the suction duct 240.

The suction duct 240 has an inclined surface 243 overhanging and inclined on the head 25 side, above the suction hole 241. The inclined surface 243 includes a +Y direction component and a -Z direction component and is inclined obliquely downward as it goes downstream in the conveyance direction. The inclined surface 243 forms a part of the side surface of the suction duct 240 on the -Y direction side. The inclined surface 243 forms a part of the outer surface of the suction duct 240. The inclined surface 243 is formed facing the front space so as to face the carriage 26. The inclined surface 243 guides an air flow AF of the gas 300 that is not sucked by the suction duct 240, into a direction of circulating the air flow AF inside the housing 100. As described above, the suction duct 240 generates the air flow AF flowing toward the nozzle surface 25A, the suction duct 240, and the linear scale 29A in this order inside the housing 100.

The suction duct 240 is formed such that the cross-sectional area along the XY plane of the suction space into which the gas 300 flows increases as it goes upward from the lower surface 244 of the suction duct 240 provided with the suction holes 241, in order to reduce the pressure loss in the suction. That is, the suction space inside the suction duct 240 increases as it goes upward from the lower surface 244 of the suction duct 240.

With the above-described configuration, the gas 300 in the front space inside the housing 100 is sucked from the suction hole 241 to above the suction duct 240 and is directed to the filter 242.

A plurality of communication parts 221 are formed in the second partition wall 220. The communication part 221 is a substantially rectangular through hole penetrating the second partition wall 220. As shown in FIG. 1, the filter 242 is provided in the communication part 221 formed in the second partition wall 220. The communication part 221 and the filter 242 are provided corresponding to the suction duct 240. The filter 242 is provided so as to seal the space between the filter 242 and the communication part 221. The filter 242 is formed, for example, as a replaceable cartridge including a member such as a nonwoven fabric.

The gas 300 sucked through the suction duct 240 passes through the filter 242. At this time, the filter 242 adsorbs the ink mist contained in the gas 300 and thus removes the ink mist from the gas 300. The gas 300 from which the ink mist has been removed flows toward the outer duct 231. In the present embodiment, the end of the filter 242 on the +Y direction side is located in the internal space of the outer duct 231, and the end of the filter 242 on the -Y direction side is located in the suction space of the suction duct 240, but the configuration of the filter 242 is not limited thereto. The suction space of the suction duct 240 and the internal space of the outer duct 231 may communicate with each other via the filter 242.

The suction duct 240 and the outer duct 231 are adjacent to each other with the filter 242 in the communication part 221 interposed therebetween. The communication part 221 is a fluid passage that couples the suction duct 240 and the outer duct 231. One communication part 221 each is provided corresponding to each of the two suction ducts 240. The communication part 221 may be, for example, a cutout formed by cutting out a part of the upper end of the second partition wall 220.

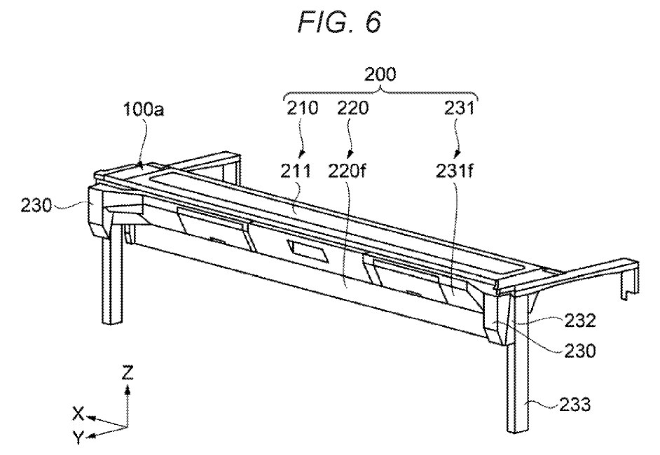

As shown in FIG. 1, the outer duct 231 guiding the gas 300 after passing through the filter 242 to the coupling part 230 (see FIG. 6) is provided at an outer surface 220f of the second partition wall 220. When the open-close cover 200 is in the closed position, the outer duct 231 is provided near the upper end of the second partition wall 220 in the Z-axis direction. In the state where the open-close cover 200 is in the closed position, the outer duct 231 is provided at a position spaced apart in the +Z direction from the lower end part of the second partition wall 220. The outer duct 231 is formed of, for example, a resin member. In the state where the open-close cover 200 is in the closed position, a bottom part which is an end of the outer duct 231 on the -Z direction side is located on the +Z direction side of the nozzle surface 25A of the head 25 and is located on the +Z direction side of the lower end part of the second partition wall 220.

The outer duct 231 is provided on the +Y direction side of the second partition wall 220. A side surface of the outer duct 231 on the -Y direction side is fixed to the outer surface 220f of the second partition wall 220. The outer surface 220f is a surface on the +Y direction side, of the surfaces of the second partition wall 220. The outer duct 231 is provided along the X-axis direction and over the second partition wall 220 in the X-axis direction.

A lower end side part located on the -Z direction side of the bottom part of the outer duct 231, of the outer surface 220f of the second partition wall 220, forms a part of the front surface 100b of the housing 100. As described above, the second partition wall 220 is formed of a light-transmissive resin member. Thus, in the state where the open-close cover 200 is in the closed position, the inside of the housing 100 is visible from outside the housing 100 through the lower end side part of the outer surface 220f.

The outer duct 231 has an outer surface 231f forming a part of the front surface 100b of the housing 100. The outer surface 231f includes a -Y direction component and a -Z direction component and is inclined obliquely downward as it goes upstream in the conveyance direction. That is, the outer surface 231f of the outer duct 231 forms a part of the front surface 100b of the housing 100 and is inclined downward.

Since the outer surface 231f is inclined downward, the space between the outer duct 231 and the blower 130 is widened. Therefore, in the state where the open-close cover 200 is in the closed position, the inside of the housing 100 is more visible from outside the housing 100 via the lower end side part of the outer surface 220f. Also, since the space between the outer duct 231 and the blower 130 is widened, the user can easily access a part upstream of the blower 130 in the conveyance direction and usability is thus improved.

As illustrated in FIG. 4, the coupling part 230 guiding the gas 300 to the inner duct 232 is provided at the two end parts of the outer duct 231 in the X-axis direction. The coupling part 230 is coupled to the inner duct 232 or separated from the inner duct 232 as the open-close cover 200 is opened or closed. In the state where the open-close cover 200 is in the closed position, the coupling part 230 has an outer coupling opening 230B that opens in the -Y direction.

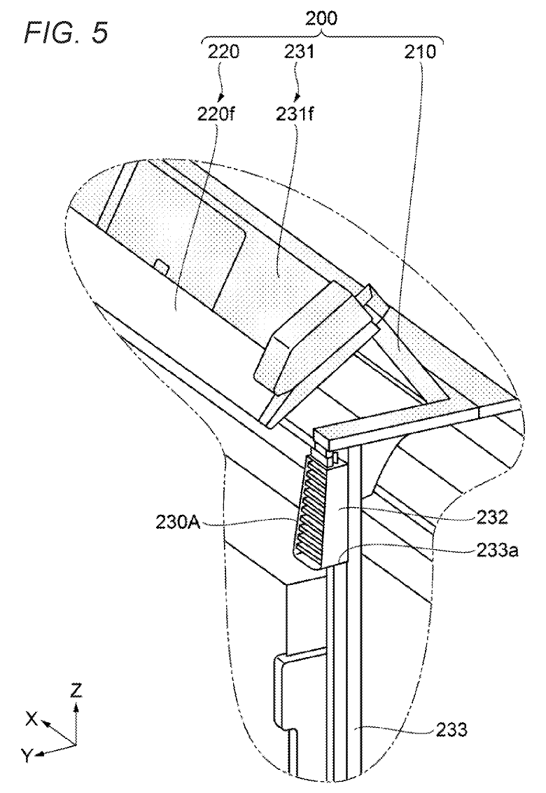

As shown in FIG. 5, the inner duct 232 is fixed to the vertical duct 233. The inner duct 232 has an inner coupling opening 230A that opens. When the open-close cover 200 is in the open position, the outer coupling opening 230B and the inner coupling opening 230A are separated from each other. As illustrated in FIG. 6, in the state where the open-close cover 200 is in the closed position, the outer coupling opening 230B and the inner coupling opening 230A are in close contact with each other and cause the outer duct 231 and the inner duct 232 to communicate with each other. The outer duct 231 and the inner duct 232 communicate with each other via the coupling part 230.

With the above-described configuration, when the open-close cover 200 is in the closed position, the gas 300 after passing through the filter 242 is sucked through the outer duct 231, the coupling part 230, and the inner duct 232 in this order, and flows toward the vertical duct 233. Since the ink mist is removed by the filter 242, the gas 300 after passing through the filter 242 contains almost no ink mist.

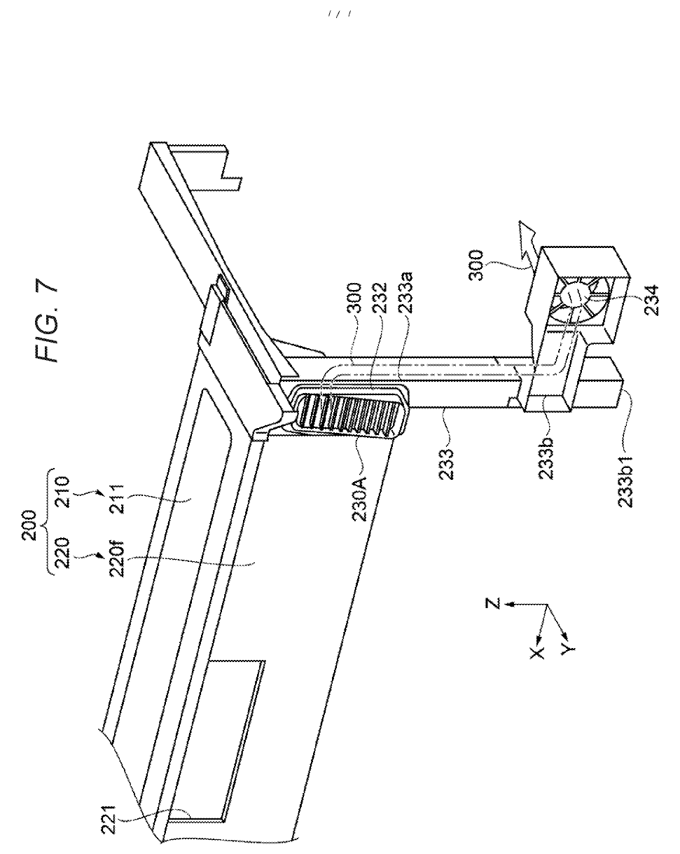

As shown in FIG. 7, the vertical duct 233 allows the inner duct 232 and the air flow generation unit 234 to communicate with each other. The vertical duct 233 is disposed closer to the air flow generation unit 234 than the inner coupling opening 230A. In other words, the vertical duct 233 is a flow path coupling the inner coupling opening 230A and the air flow generation unit 234. The vertical duct 233 is formed of, for example, a hollow angular member. The vertical duct 233 also functions as a frame forming the housing 100. In FIG. 7, for the convenience of the description of the configuration of the inner duct 232, the component members provided on the +Y direction side of the second partition wall 220 are not illustrated.

The gas 300 flowing from the inner coupling opening 230A flows into an upper opening 233a. The gas 300 flows out from a lower opening 233b toward the air flow generation unit 234. The lower opening 233b is formed above a lower end 233b1 of the vertical duct 233.

The air flow generation unit 234 includes an exhaust fan that discharges the gas 300 to outside the housing 100. The air flow generation unit 234 also functions as a duct having an opening coupled to the lower opening 233b and an exhaust port, not illustrated, facing the -Y direction. In FIG. 7, for the convenience of the description of the configuration of the lower opening 233b, the component members provided on the +Y direction side of the air flow generation unit 234 are not illustrated.

The air flow generation unit 234 is controlled by the control unit 13. For example, in the state where the open-close cover 200 is in the closed position, the control unit 13 controls the printing unit 3 to eject the ink from the nozzles 28 and thus perform printing on the medium 2. At this time, the control unit 13 controls the air flow generation unit 234 to suck the gas 300 inside the housing 100 from the suction hole 241 in the suction duct 240.

With the above-described configuration, the gas 300 after passing through the vertical duct 233 is sucked by the air flow generation unit 234 and directed to outside the housing 100. As described above, the printing device 1 has the configuration for sucking the ink mist.

Thus, the gas 300 (see FIG. 1) containing the ink mist sucked from the suction hole 241 in the suction duct 240 passes through the filter 242, which adsorbs the ink mist contained in the gas 300. Then, the gas 300 from which the ink mist is removed by passing through the filter 242 passes through the outer duct 231 and flows into the inner duct 232 via the coupling part 230 (see FIG. 6). Moreover, the gas 300 flowing into the inner duct 232 passes through the vertical duct 233 (see FIG. 7) and is discharged to outside the housing 100 via the air flow generation unit 234. Thus, the printing device 1 can remove the gas 300 containing the ink mist staying inside the housing 100, to outside the housing 100.

Although the configuration of the flow path up to the point of discharging the gas 300 inside the housing 100 to outside the housing 100 is described mainly with respect to the -X direction side from the center of the printing device 1 in the X-axis direction, the flow path on the +X direction side, too, has substantially the same configuration.

As described above, the printing device 1 according to the present embodiment can achieve the following advantageous effects.

The printing device 1 according to the present embodiment includes the open-close cover 200, which includes the first partition wall 210 forming a part of the top surface 100a of the housing 100 and the second partition wall 220 forming a part of the front surface 100b of the housing 100 and opens and closes a part of the housing 100. The printing device 1 includes the head 25, which is accommodated in the housing 100 and discharges a liquid from the nozzle surface 25A to the medium 2. The printing device 1 includes the carriage 26, which supports the head 25 and moves along the scanning direction by being guided by the guide shaft 27 extending along the scanning direction. The printing device 1 further includes the suction duct 240, which sucks the gas 300 inside the housing 100 from the suction hole 241. The suction duct 240 is located on the side opposite to the guide shaft 27 across the head 25 as viewed in a plan view and is provided at the inner surface 220b of the second partition wall 220.

According to the present embodiment, the suction duct 240 is located on the side opposite to the guide shaft 27 across the head 25 and is provided at the inner surface 220b of the second partition wall 220. Thus, since the suction duct 240 does not overlap the guide shaft 27 in the up-down direction, an increase in the height of the printing device 1 can be suppressed.

Also, according to the present embodiment, since the second partition wall 220 extends below the suction duct 240, the second partition wall 220 can guide the gas 300 on the lower side inside the housing 100 to the suction duct 240.

According to the present embodiment, the second partition wall 220 is light-transmissive below the suction duct 240. Thus, the user can easily view the printing state inside the housing 100 from outside the housing 100 via the second partition wall 220.

According to the present embodiment, the suction hole 241 is formed at a position close to the nozzle surface 25A of the suction duct 240. Thus, since the ink mist is sucked at a position close to the ink mist generation source, the spread of the ink mist can be reduced.

According to the present embodiment, the suction hole 241 is formed at the lower surface 244 of the suction duct 240. Thus, since the ink mist is sucked at a position close to the ink mist generation source, the spread of the ink mist can be reduced.

According to the present embodiment, since the internal space of the suction duct 240 is widened as it goes upward from the lower surface 244 of the suction duct 240, the pressure loss in the suction can be reduced in the suction duct 240.

According to the present embodiment, since the suction hole 241 is formed along the scanning direction, the ink mist can be sucked over the range in which the nozzle surface 25A, which is the ink mist generation source, moves.

According to the present embodiment, the printing device 1 further includes the upstream conveying unit 7, which conveys the medium 2 in the conveyance direction, and the suction duct 240 is located downstream of the carriage 26 in the conveyance direction, and therefore the volatile component generated from the printed medium 2 can be sucked.

While the present embodiment has been described in detail above with reference to the drawings, the specific configurations are not limited to the present embodiment and may be changed, replaced, deleted or the like without departing from the gist of the present disclosure. Also, other embodiments given below may be employed.

In the above embodiment, in the configuration of the flow path up to the point of discharging the gas 300 inside the housing 100 to outside the housing 100, the flow path on the -X direction side and the flow path on the +X direction side of the center of the printing device 1 in the X-axis direction may not be substantially the same. For example, flow paths having different shapes or the like may be formed on the -X direction side and the +X direction side of the center of the printing device 1, and the gas 300 inside the housing 100 may thus be discharged to outside the housing 100.

In the above embodiment, the plurality of communication parts 221 may not be provided in the second partition wall 220. For example, one communication part 221 may be provided at the center of the second partition wall 220 in the X-axis direction. In this case, one suction duct 240 may be provided over the second partition wall 220 in the X-axis direction.

In the above embodiment, the side surface of the outer duct 231 on the +Z direction side may be fixed to the first partition wall 210, in addition to the side surface of the outer duct 231 on the -Y direction side being fixed to the outer surface 220f of the second partition wall 220.

In the above embodiment, the internal space of the outer duct 231 may be formed by the outer duct 231 and the outer surface 220f of the second partition wall 220. In this case, the side surface of the outer duct 231 on the +Z direction side may be fixed to the first partition wall 210, and the bottom part of the outer duct 231 may be fixed to the outer surface 220f of the second partition wall 220. In this case, the side surface of the outer duct 231 on the -Y direction side may not be provided.

What is claimed is:

1. A printing device comprising:
an open-close cover that includes a first partition wall forming a part of a top surface of a housing and a second partition wall forming a part of a front surface of the housing and opens and closes a part of the housing;
a liquid ejection unit that is accommodated in the housing and ejects a liquid to a medium from an ejection surface;
a carriage that supports the liquid ejection unit, and is guided by a guide shaft extending along a scanning direction and thus moves along the scanning direction; and
a suction duct that sucks a gas inside the housing from a suction hole, wherein
the suction duct is located on a side opposite to the guide shaft across the liquid ejection unit as viewed in a plan view, and is provided at an inner surface of the second partition wall.

2. The printing device according to claim 1, wherein
the second partition wall extends below the suction duct.

3. The printing device according to claim 2, wherein
the second partition wall is light-transmissive below the suction duct.

4. The printing device according to claim 1, wherein
the suction hole is formed at a position close to the ejection surface, in the suction duct.

5. The printing device according to claim 4, wherein
the suction hole is formed at a lower surface of the suction duct.

6. The printing device according to claim 5, wherein
an internal space of the suction duct is widened as it goes upward from the lower surface.

7. The printing device according to claim 1, wherein
the suction hole is formed along the scanning direction.

8. The printing device according to claim 1, further comprising:
a medium conveying unit that conveys the medium in a conveyance direction, wherein
the suction duct is located downstream of the carriage in the conveyance direction.
